(19) United States
(12) Patent Application Publication
(10) Pub. No.: US 2005/0138750 A1
(43) Pub. Date: Jun. 30, 2005

(54) Apparatus for cleaning a paint roller

(76) Inventors: Edward Trincilla, New York, NY (US); Robert Mirabella, New York, NY (US)

Correspondence Address: ROBERT S. SMITH, 1131-0 TOLLAND TURNPIKE, SUITE 306, MANCHESTER, CT, 06040, US

(21) Appl. No.: 10/746,647

(22) Filed: Dec. 29, 2003

(51) Int. Cl. B05C 21/00

(52) U.S. Cl. 15/236.03

(57) ABSTRACT

A paint roller cleaning apparatus that includes both apparatus for removing paint from paint rollers as well as apparatus for the removal of the roller from the structure that supports the roller which includes a first elongated open channel, a second elongated open channel, and apparatus for registering the first elongated open channel with the second elongated open channel in opposed relationship. In some forms of the invention the paint roller cleaning apparatus the apparatus for registering the first open channel with the second open channel in opposed relationship includes first and second arms and a pivot joining the first and second arms. In some cases the first open channel has a first axis, the second open channel has a second axis and the pivot has a third axis, and each axis is parallel to each other axis. In some forms of the invention the first and second open channels are each cylindrical sections and the apparatus may further include a locking mechanism engaging the first and second arms to hold of the first and second open channels in abutting facing relationship to define a passageway for an associated roller cover. The first and second open channels may define a generally cylindrical passageway.

### BACKGROUND OF INVENTION

The invention relates to painting apparatus and particularly to apparatus for cleaning a paint roller that includes both apparatus for removing paint from paint rollers as well as apparatus for the removal of the roller from the structure that supports the roller. Paint rollers are a convenient means for applying paint and the like to many surfaces. Typically, a paint roller handle assembly includes (1) a handle, having a first axis, dimensioned and configured for the gripping by the user and (2) an attached rotatably mounted cylindrical support, having a second axis that is substantially perpendicular to the first axis. Replaceable covers or cartridges are dimensioned and configured for frictional engagement with the outer face of the rotatably mounted cylindrical member. A problem with such apparatus is the difficulty of cleaning the apparatus after it has been used to apply paint or other coatings. The problem includes both the problem of removing the entire roller as well as extracting paint from the roller to avoid wasting the paint. A variety of apparatus have been used for these purposes. The known apparatus for cleaning has not been wholly satisfactory. Users of such equipment often rinse the cover in a running stream of water or soak the roller in a container in an effort directed solely to saving the cover for future use. Such a practice does not seek to save the paint or other coating that may be on the cover at the time that cleaning process is started. This practice corresponds to the practice that is traditional with paint brushes. More particularly it is common, particularly with water-based paints, to clean the brush with a running stream of water and/or soak the brush in water or other solvent. Such practices ignore the value of the paint or other coating that may be on the roller when the cleaning process is started.

In addition, the process for removing the cover from the handle assembly, even when the user of such apparatus only desires to remove the used cover and dispose of that cover, is difficult. This process is complicated by the messiness of the cover as well as the slipperiness of the wet cover. Thus, the user will instinctively attempt to avoid soiling him or herself as well as his or her clothing despite the difficulty of firmly gripping the cover.

### SUMMARY OF THE INVENTION

It is an object of the present invention to provide apparatus that will maximize the recovery of the paint or other material that may be deposited on the cover when the painting process has been completed.

Another object of the present invention is to provide apparatus that is simple and inexpensive to manufacture.

Yet another object invention is to provide apparatus that is easy to use and which makes possible the easy removal of paint from the cover that would be otherwise wasted.

Still another object invention is to provide apparatus that facilitates gripping the cover for removal from the handle assembly in a manner that is both neat and effective despite the messiness and slipperiness of the removable cover.

It is now been found that these and other objects of the invention may be attained in a paint roller cleaning apparatus that includes both apparatus for removing paint from paint rollers as well as apparatus for the removal of the roller from the structure that supports the roller which includes a first elongated open channel, a second elongated open channel, and apparatus for registering the first elongated open channel with the second elongated open channel in opposed relationship.

In some forms of the invention the paint roller cleaning apparatus the apparatus for registering the first open channel with the second open channel in opposed relationship includes first and second arms and a pivot joining the first and second arms. In some cases the first open channel has a first axis, the second open channel has a second axis and the pivot has a third axis, and each axis is parallel to each other axis. In some forms of the invention the first and second open channels are each cylindrical sections and the apparatus may further include a locking mechanism engaging the first and second arms to hold of the first and second open channels in abutting facing relationship to define a passageway for an associated roller cover. The first and second open channels may define a generally cylindrical passageway.

In some forms of the invention the first and second open channels have a rough interior face abutting the passageway to maximize engagement with an associated roller cover. The rough interior face may be a metallic surface having protrusions extending toward an associated roller cover disposed within the passageway and the protrusions may have sharp edges.

In some forms of the invention the apparatus may include structure defining a circular opening dimensioned and configured for engaging the outer surface of an associated roller cover to extract paint on the surface thereof. The structure defining the circular may be concentric with the passageway and may have a smaller diameter than the passageway. In some cases the structure defining a circular opening defines that opening as a substantially cylindrical surface.

The first and second open channels may extend beyond the substantially cylindrical surface. The substantially cylindrical surface may have a first axial extremity and a second axial extremity and the first and second open channels may include at least a first axial portion thereof that extends beyond the first axial extremity of the substantially cylindrical surface and the first axial portion includes at least a part thereof that is generally cylindrical. Similarly, the substantially cylindrical surface may have a second axial portion thereof that extends beyond the second axial extremity of the substantially cylindrical surface and the second axial portion may include at least a part thereof that is generally cylindrical.

The invention also includes the method for extracting paint from the nap of a paint roller which includes providing a body having a circular opening therein that is dimensioned and configured for interfering relationship with the nap of an associated paint roller and pushing the associated paint roller through the circular opening.

### BRIEF DESCRIPTION OF THE DRAWINGS

The invention will be better understood by reference to the accompanying drawing in which:

FIG. 1 is a front elevation view of one form of a first embodiment of the present invention that is particularly adapted for removal of a replaceable cover from a paint roller assembly and which shows the jaws thereof in the open position.

FIG. 2 is a side elevation view of the apparatus illustrated in FIG. 1 in which the jaws thereof are closed about a bag that surrounds a roller which is mounted on a handle assembly that includes a rotatably mounted cylindrical support.

FIG. 3 is a front elevation view of one form of a second embodiment of the present invention that is particularly adapted for removal of paint from the replaceable cover while the cover is mounted on a paint roller assembly that includes a rotatably mounted cylindrical support and which shows the jaws thereof in the open position.

FIG. 4a is a fragmentary section view of the jaws of the apparatus illustrated in FIG. 3 which shows the jaws thereof positioned to move coaxially with respect to the roller tool a positioned in which the jaws compress the surface of the roller.

FIG. 4b is a fragmentary section view of the jaws of the apparatus illustrated in figure three which shows the jaws thereof positioned to approach the roller radially, after which the jaws will be closed against the side of the roller to compress the surface of the roller.

FIG. 4c is a fragmentary side elevation view of the jaws of the apparatus shown in FIG. 3 after the jaws had been moved axially along the axial extend of the roller to extract paint from the roller.

### DESCRIPTION OF THE PREFERRED EMBODIMENTS

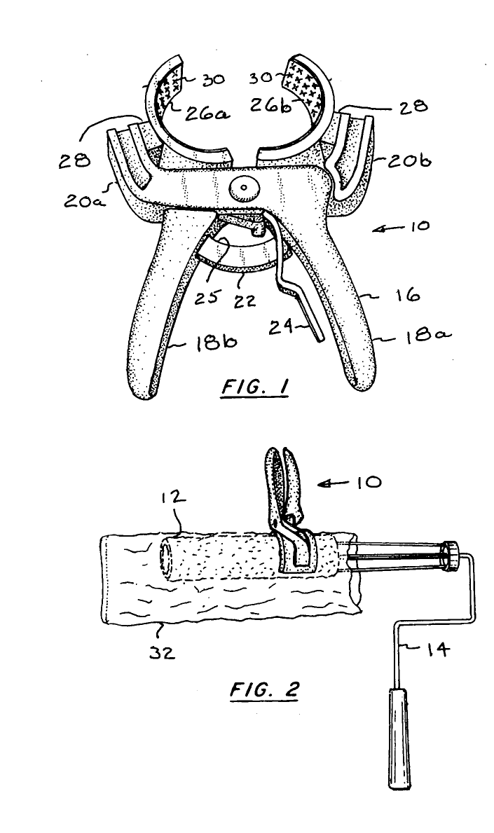

Referring now to FIGS. 1 and 2 there is shown one form of a first embodiment of apparatus 10 that is particularly adapted for removal of a roller cover or cartridge 12 from a handle assembly 14. The apparatus 10 includes, in a preferred embodiment, a modified form of ratcheting pliers 16 such as the QUICK-GRIP HANDI-CLAMP manufactured by Irwin Industrial Tools, a unit of Newell Rubbermaid Inc. based in Atlanta Ga. Other embodiments utilize other plier mechanisms.

This commercially available product combines essentially a conventional plier mechanism having opposed handles 18a and 18b. Squeezing of the handles 18a and 18b causes opposed jaws 20b and 20a to clamp about a workpiece, namely the roller 12. In addition the ratcheting pliers 16 includes an arcuate arm 22 fixed to the handle 18b. The arcuate arm 22 moves freely with respect to the handle 18a. A locking member 24 engages teeth 25 on the upper edge of the arcuate arm 22 to achieve a ratcheting function whereby when the opposed handles 18a and 18b are squeezed together, the opposed jaws 20a and 20b we'll not move apart and tell the locking member 24 is touched. Movement of the locking member 24 by the user releases the ratcheting lock.

Mounted on the opposed jaws 20a and 20b are respective opposed cylindrical section elements 26a and 26b. In some cases the dimensions of the ratcheting plier 16 and the roller cover or cartridge 12 may require respective a spacer 28 intermediate the jaw 20a and the cylindrical section element 26a as well another spacer 28 intermediate the jaw 20b and the cylindrical section element 26b. Other embodiments will have plier mechanisms that are dimensioned and configured in a manner that will not require such spacers 28.

In the preferred embodiment the opposed cylindrical section elements 26a and 26b each have an angular extent of 180° whereby when the jaws 20a and 20b are closed the mating cylindrical section elements 26a and 26b will collectively defined a cylindrical passageway therebetween. Each of the cylindrical section elements 26a and 26b has an inner face 30 that is intentionally very rough. This roughness is important to ensure that there is positive engagement between the surfaces 30 and the associated roller cover 12 that is to be removed from a handle assembly 14. In a preferred embodiment the inner face 30 is manufactured with a surface that resembles a cheese grater. In other words, the surface has a plurality of teeth like elements extending over the entire surface thereof. Other embodiments will utilize various very rough surfaces to insure the requisite gripping. The inner face 30 may be riveted to a discrete cylindrical section member in some embodiments. Other embodiments may have the inner face 30 molded as an integral part of the respective mating cylindrical section elements 26a and 26b.

The preferred manner of use of this apparatus is illustrated in FIG. 2. A bag 32 for disposal of the roller cover or cartridge 12 is placed over the roller cover 12 while it is mounted on the handle assembly 14. Then the user clamps the inner surfaces 30 against the roller cover 12 with the bag 32 intermediate the inner surfaces 30 and the roller cover 12. The user then uses the apparatus 10 as a handle to apply a force that is axial with respect to the roller cover 12 to move the roller cover 12 off of the handle assembly 14. The users can then release the engagement of the inner surfaces 30 from the roller cover 12 by touching the locking number 24. The user then moves the bag 32 to the upright position to cause the roller cover 12 to fall to the bottom of the bag 32 for ease in final disposal.

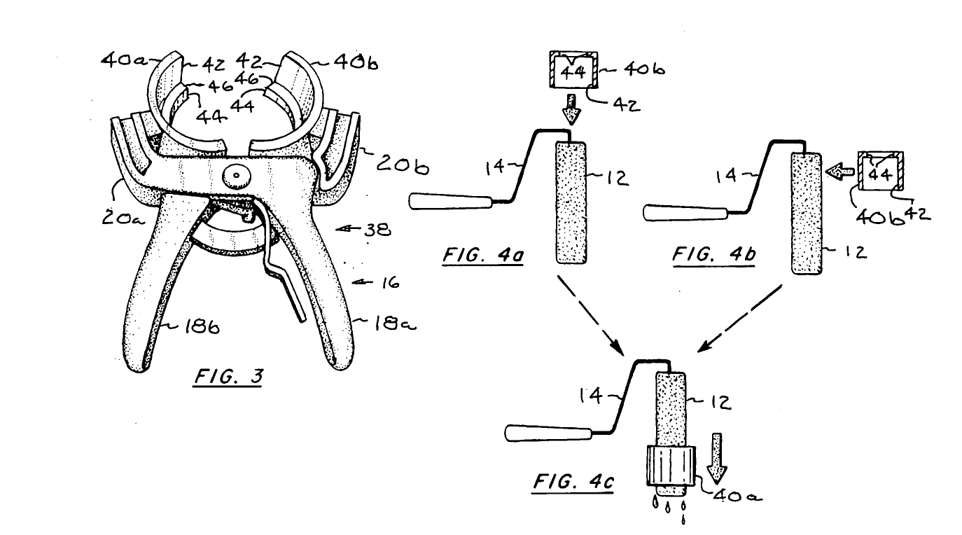

Referring now to FIGS. 3-4c there shown another embodiment of the present invention that is particularly adapted for removal of paint from the replaceable cover 12 while a cover is mounted on a paint roller assembly 14. This embodiment is also intended to clean a roller cover 12, however, it is particularly adapted to recovering paint that may be on a roller 12 when a painting job is completed. It is desirable to remove this paint to reduce the environmental impact of the paint that might otherwise be thrown away as well as to save paint that can be used at some later time instead of being wasted by being thrown away.

The embodiment of FIGS. 3-4c includes apparatus 38 including a ratcheting plier 16 of the type shown in the embodiment of FIGS. 1-2. Although conventional pliers may also be used there is an advantage to the locking mechanism in each embodiment. The difference between the apparatus 10 and the apparatus 38 and particularly the embodiment of FIGS. 3-4c is the cylindrical section elements 40a and 40b mounted with respective spacers 28 therebetween, respectively on the jaws 20a and 20b in the embodiment illustrated in FIG. 3. The cylindrical section elements 40a and 40b are mirror images of each other. The geometric configuration of cylindrical section elements 40a, 40b is best seen in FIG. 3. Each cylindrical section element 40a, 40b, in the preferred embodiment, includes an inner face defined by successive cylindrical axial sections. The first cylindrical axial section 42 having a first inner diameter and a second cylindrical axial section 44 having a smaller inner diameter. The interface between the first axial section 42 and the second axial section 44 thus define a shoulder or step 46.

As best seen in FIGS. 4a-4b the apparatus 38 is preferably used by moving the section elements 40a and 40b apart and either moving the cylindrical section elements 40a and 40b of the apparatus 38 axially with respect to the roller 12 as shown in FIG. 4a or radially with respect to the roller 12 as shown in FIG. 4b and then placing the second cylindrical axial section 44 having a smaller inner diameter in firm interfering engagement with the roller cover 12 near the upper (as viewed in FIGS. 4a-4b) end thereof. As shown in FIGS. 4a-4b second cylindrical axial section 44 having a smaller inner diameter is positioned at a higher elevation than the first cylindrical axial section 42 having a first inner diameter. Thereafter the user uses the apparatus 38 to force the second cylindrical axial section 44 having a smaller inner diameter along the entire axial extent of the replaceable cover 12. During this movement the first axial section 42 assists in directing paint removed from the roller cover 12 downwardly (as best seen in FIG. 4c) into a paint bucket (not shown).

Various embodiments of the invention may have various configurations of the cylindrical section elements 40a and 40b. Each of them will ordinarily include a cylindrical shape. Although not preferred it is possible that some embodiments may have a planar member having a circular hole therein through which the roller cover is forced to extract the paint from the nap of the roller cover 12. It is this snug engagement that is essential to extracting paint from the nap of the roller cover 12. The precise dimensions of the apparatus will vary with the construction of the individual roller cover 12 including the nap on the face thereof and the nature of the paint or other material with which the roller cover 12 is being used. In other words, the inner diameter of the collar 44 (or planar member having a circular hole) with the roller cover 12 will ordinarily be smaller if the nap of the roller cover 12 is less dense or the viscosity of the paint is less than the usual paint.

The invention has been described with reference to the preferred embodiments. Persons skilled in the art of such inventions may upon exposure to the teachings herein, conceive other variations. Such variations are deemed to be encompassed by the disclosure, the invention being delimited only by the following claims.

1. A paint roller cleaning apparatus which comprises:
a first elongated open channel;
a second elongated open channel; and
means for registering said first elongated open channel with said second elongated open channel in opposed relationship.

2. The paint roller cleaning apparatus in accordance with claim 1 wherein said means for registering said first open channel with said second open channel in opposed relationship includes first and second arms.

3. The paint roller cleaning apparatus in accordance with claim 1 wherein said means for registering said first open channel with said second open channel in opposed relationship includes a pivot joining said first and second arms.

4. The paint roller cleaning apparatus in accordance with claim 3 wherein said first open channel has a first axis, said second open channel has a second axis and said pivot has a third axis, each said axis being parallel to each other said axis.

5. The paint roller cleaning apparatus in accordance with claim 1 wherein said first and second open channels are each cylindrical sections.

6. The paint roller cleaning apparatus in accordance with claim 3 further including a locking mechanism engaging said first and second arms to hold of said first and second open channels in abutting facing relationship to define a passageway for an associated roller cover.

7. The paint roller cleaning apparatus in accordance with claim 3 six wherein said first and second open channels define a generally cylindrical passageway.

8. The paint roller cleaning apparatus in accordance with claim 7 wherein said first and second open channels have a rough interior face abutting said passageway to maximize engagement with an associated roller cover.

9. The paint roller cleaning apparatus in accordance with claim 8 wherein said rough interior face is a metallic surface having protrusions extending toward an associated roller cover disposed within said passageway.

10. The paint roller cleaning apparatus in accordance with claim 9 wherein said protrusions have sharp edges.

11. The paint roller cleaning apparatus in accordance with claim 3 further including structure defining a circular opening dimensioned and configured for engaging the outer surface of an associated roller cover to extract paint on the surface thereof.

12. The paint roller cleaning apparatus in accordance with claim 11 wherein said structure defining a circular opening, defines said circular opening to be concentric with said passageway and with a smaller diameter than said passageway.

13. The paint roller cleaning apparatus in accordance with claim 12 wherein said structure defining a circular opening defines that opening as a substantially cylindrical surface.

14. The paint roller cleaning apparatus in accordance with claim 13 wherein said first and second open channels extend beyond said substantially cylindrical surface.

15. The paint roller cleaning apparatus in accordance with claim 14 wherein said substantially cylindrical surface has a first axial extremity and a second axial extremity and said first and second open channels include at least a first axial portion thereof that extends beyond said first axial extremity of said substantially cylindrical surface, said first axial portion including at least a part thereof that is generally cylindrical.

16. The paint roller cleaning apparatus in accordance with claim 15 wherein said substantially cylindrical surface has a second axial portion thereof that extends beyond said second axial extremity of said substantially cylindrical surface, said second axial portion including at least a part thereof that is generally cylindrical.

17. The method for extracting paint from the nap of a paint roller which comprises:
providing a body having a circular opening therein that is dimensioned and configured for interfering relationship with the nap of an associated paint roller; and
pushing the associated paint roller through the circular opening.

18. A liquid removal apparatus, comprising:
a pliers having first and second elongated members on which are disposed respective first and second jaws, and first and second cylindrical sections fixed respectively to said first and second jaws.

19. The apparatus has claimed in claim 18, wherein said cylindrical sections and said pliers are plastic.

20. The apparatus as claimed in claim 18, wherein said first and second cylindrical sections consist essentially of first and second semi-cylindrical parts, each of said first and second parts being a unitary member respectively with said first and second elongated members.

21. The apparatus as claimed in claim 18, wherein said cylindrical sections include a rough surface.

22. The apparatus as claimed in claim 18, wherein said cylindrical sections includes protrusions.

23. The apparatus as claimed in claim 18, wherein said cylinder will sections are configured and dimensioned to remove a fluid from a roller cover disposed on a fluid roller assembly.

24. A system for use with roller covers disposed on respective fluid roller assemblies which comprises:
a first pliers having first and second elongated members on which are disposed respective first and second jaws and first and second cylindrical sections fixed respectively to said first and second jaws, said first and second cylindrical sections having protrusions thereon, and
a second pliers having first and second elongated members on which are disposed respective first and second jaws and first and second cylindrical sections fixed respectively to said first and second jaws that are dimension in configured for extraction of liquid from an associated roller cover.
